(19) United States
(12) Patent Application Publication
(10) Pub. No.: US 2020/0191270 A1
(43) Pub. Date: Jun. 18, 2020

(54) T-seal

(71) Applicant: Ferro-Tube Oil Tools Co., L.P., Spring, TX (US)

(72) Inventor: Joseph Diaz, Spring, TX (US)

(73) Assignee: Ferro-Tube Oil Tools Co., L.P.

(21) Appl. No.: 16/217,239

(22) Filed: Dec. 12, 2018

(51) Int. Cl. F16J 15/02; E21B 33/14; E21B 17/14

(52) U.S. Cl. CPC F16J 15/022; E21B 34/06; E21B 17/14; E21B 33/14

(57) ABSTRACT

The disclosure includes an apparatus and method for using a T-seal. The T-seal includes a main body, a protrusion extending from the exterior surface of the main body, wherein the protrusion is configured to secure the T-seal into a T-seal groove disposed in the interior wall of the shell of a float shoe or float collar. The T-seal prevents annulus formation and/or leakage during use of the float equipment.

### BACKGROUND

### Field

This application relates to a seal for use in float equipment for the oil and gas industry. More particularly, this application relates to a seal used in a float shoe or float collar to prevent annulus leaks within the float equipment.

### Description of the Related Art

Float equipment, including float shoes and float collars, is generally intended to reduce the hook weight on the drilling rig when running the casing downhole during the drilling of an oil well. The float equipment also helps to guide the casing down into the wellbore past ledges and sidewall obstructions and irregularities. As operators design wells with increasing lateral lengths and longer horizontal sections, running casing to “total depth” has become more challenging. The longer the lateral, the more drag and friction forces impede the process of running casing to bottom. Once at total depth, the float equipment must still be functional for cementing the casing within the wellbore.

Float equipment has become an essential part to the drilling of a well. Float equipment design and selection involves nuances that, if not accounted for, could provide partial or complete failure of the float equipment. The float equipment must withstand extreme conditions of backpressure, plug bump pressure, tensile force, and flow-induced abrasion. Failure of the float equipment requires the removal of the casing from the wellbore and, often times, total replacement of the float equipment, resulting in rig downtime and increased production costs. Therefore, an improvement to the structural integrity and durability of the float equipment is vitally important to the reduction of downtime and the increased profitability of drilling operations.

### SUMMARY

A design and method for using a T-seal is provided. Float equipment includes a float shoe and/or a float collar. Each of the float shoe and float collar comprises a length of pipe connected to the casing string, with a non-return valve, referred to herein as a “check valve,” encased by cement. The float shoe consists of a rounded or pointed component, commonly known as a “nose,” attached to the downhole end of the casing or pipe string. The nose can be cement, phenolic, or aluminum. In many cases, a phenolic or aluminum nose is screwed into the body, which is then attached to the downhole end of a casing on a pipe string. The casing or pipe used to manufacture the float equipment is configured to house a variety of sizes and types of valves, including most notably, one or more check valves, which can include flapper type valves activated by pressured ball activation methods or plunger-type valves. The float shoe consists of a tubular metal body, filled with cement or cement-like material, having a longitudinal bore surrounding and securing in place a valve made of a composite or aluminum housing. In most embodiments, the encasing material is a cement composite used to secure the check valve within the float shoe body and/or float collar body and is manufactured to allow for a fast and efficient drill out after the cementing stage is complete.

One aspect of this disclosure is to provide a relatively inexpensive modification to existing methods of manufacture of float equipment to improve the float equipment's performance and durability.

Another aspect of this disclosure is to provide a means to prevent leaks about an annulus or a micro annulus formed within the float equipment. For example, to prevent leaks between the float shoe cementing material and the internal wall of the casing.

These and other aspects of the disclosure are achieved by a float shoe and/or float collar adapted for a variety of well installations.

Additional aspects of the invention include methods of making and using the T-seal in accordance with the foregoing aspects. It should also be noted that the invention further encompasses the various possible combinations of the aspects and features disclosed herein.

### BRIEF DESCRIPTION OF THE DRAWINGS

FIG. 1 depicts a T-seal, as shown and described herein.

FIG. 2 depicts a side view of a T-seal, as shown and described herein.

FIG. 3 depicts a cross-sectional view of a float collar with a T-seal groove, as shown and described herein.

FIG. 3a depicts a close-up cross-sectional view of a float collar with a T-seal groove, as shown and described herein.

FIG. 3b depicts a close-up cross-sectional view of a T-seal groove with T-seal profile, as shown and described herein.

FIG. 4 depicts a cross-sectional view of a section of casing with a T-seal, as shown and described herein.

FIG. 4a depicts a close up view of the i-seal in the T-seal groove, as shown and described herein.

FIG. 5 depicts a sectional cut-out view of a float collar, as shown and described herein.

FIG. 6 depicts a sectional cut-out view of a float shoe with nose, as shown and described herein.

### DETAILED DESCRIPTION

The disclosed T-seal can be incorporated into any one or more portions of the casing. The term “float equipment” generally refers to a float collar or a float shoe, which are known in the industry to be found at and/or in the initial lengths of casing when running the casing downhole. For simplicity of its description herein, the disclosure with refer primarily to a “float shoe,” which shall have the common meaning known in the industry. However, the same principles and embodiments disclosed herein can also be applied to the float collar.

The shell of the float shoe is typically made of steel, cylindrical in shape, and generally match the casing size and threads, although not necessarily the casing grade. Inside the wall of the float shoe (including the taper) usually contains cement or thermoplastic used to secure a valve about its center. The cement material is typically drilled out if the well is to be deepened beyond the cementing depth, and its composition can be selected accordingly. The quality of cement and its ability to bind to the interior surface of the float shoe wall is important. The shrinkage and shear bond of the cement determine the sealing ability between the shell and the valve and prevent the cured cement from spinning inside the shell during drillout. The cement's compressive strength and flexural strength are directly related to its ability to support plug bump pressures and retain backpressure. Additionally, to prevent failure, the float equipment should have a backpressure rating that exceeds the true hydrostatic pressure and temperature at total depth.

During manufacture of the float shoe or float collar, the cement used to set the valve must dry, and in doing so, has a risk of shrinking or otherwise failing to completely seal with the interior wall of the Shell, which can result in one or more micro-annuluses or leaks between the cement and the interior wall of the float shoe. To increase the structural integrity and decrease the risk of failure of the float equipment, a T-seal can be included in the interior wall of the float shoe and/or float collar to prevent leakage of fluid between the cement and the internal wall of the float shoe. The T-seal can be positioned with a cut-out, or “T-seal groove,” made in the interior wall of the float shoe.

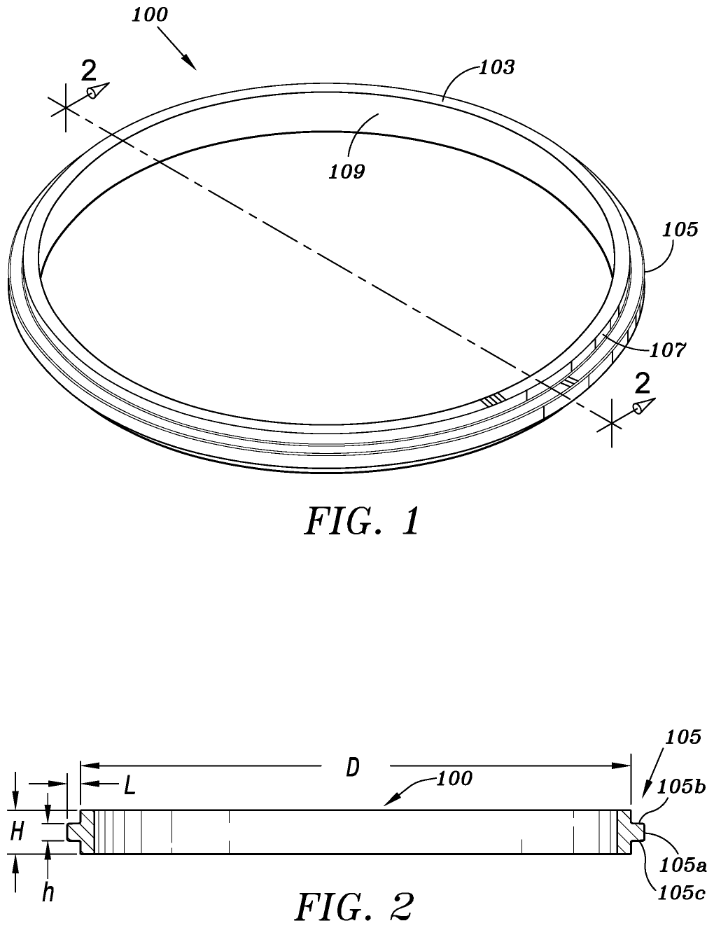

FIG. 1 depicts a T-seal 100 and FIG. 2 depicts a side view of the T-seal 100. The T-seal 100 is configured to fit the interior surface of a shell, and as such is generally circular in shape and, for nomenclature purposes only, is generally related to a band or a ring. Therefore, references to the “interior surface” or “exterior surface” of the ring can be understood in the context of a ring like structure having an inner diameter and an outer diameter. However, in different applications the general shape of the T-seal could be different (i.e., square, oval, triangular, etc.) and, though this disclosure does not go into a detailed explanation of those shapes, the same concepts should be understood to apply.

The T-seal is made up of a main body 103 and can have a projection 105 extending from the exterior surface 107 of the main body 103. The inside surface 109 can be generally plain, but in one or more embodiments (not shown), a projection similar to or different from the outside projection 105 can extend inwardly therefrom. The T-seal 100 can have a predetermined height H and outer diameter D, and inner diameter. The difference in outer diameter and inner diameter is determined by the thickness of the T-seal 100. The projection 105 can also have a predetermined height h and a predetermined length of extension L.

The T-seal 100 can be made of a variety of materials. In one or more embodiments, the T-seal 100 can be made of an expandable material and/or a flexible material. For example, such material can expand and/or contract when exposed to (a change in) variables such as temperature, pressure, electromagnetic radiation, moisture, one or more chemicals, or a combination thereof. Notably, the T-seal 100 can be made of a rubber composite that expands when it comes into contact with water or other liquid compositions. The T-seal 100 can be made of a nitrile rubber composite.

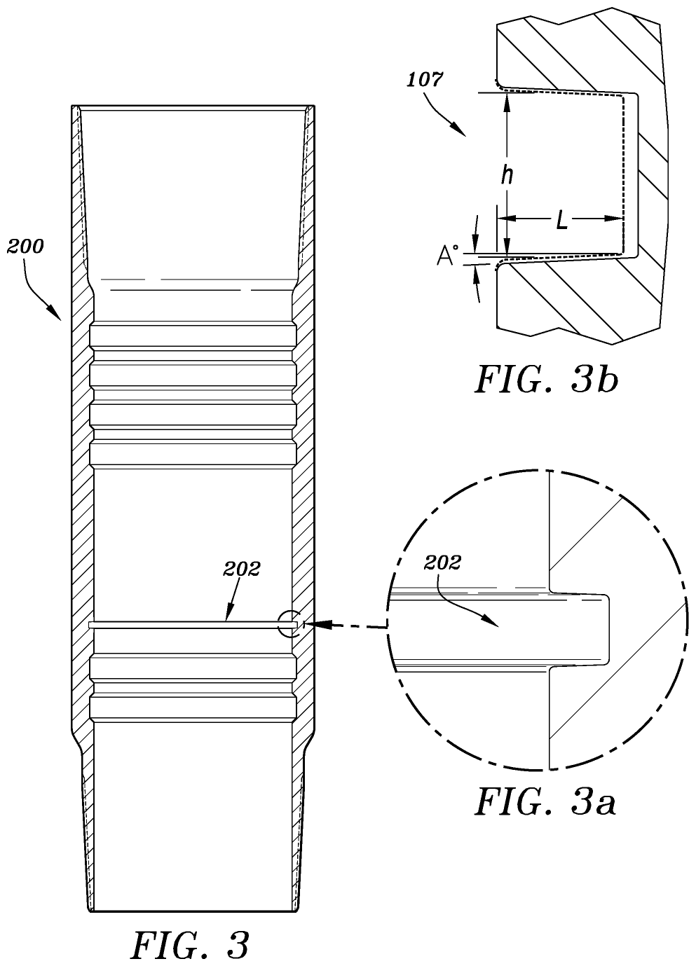

FIG. 3 depicts a cross-sectional view of a shell 200 with a T-seal groove 202. The T-seal groove 202 can be specially cut-out during manufacture of the shell 200 to be used for the float equipment, including both casting and billet manufacturing procedures. The T-seal groove 202 can also be created post manufacturing of the shell 200, and is often accomplished by machining or cutting out the groove 202.

FIG. 3A depicts a close-up cross-sectional view of a casing with a T-seal groove. In one or more embodiments, the T-seal can be made of an expanding material. To accommodate such expansion, the T-seal 100 and T-seal groove 202 can be selectively sized such that the dimensions of the T-seal groove 202 can accommodate the T-seal both prior to and after expansion. As shown in FIG. 3B, the projection 105 of the T-seal 100 can expand about its height h and/or its depth or length L. In one or more embodiments, the expansion of the projection's height h may not be uniform, expanding more or less at its distal end than it expands at its end proximal to the main body 103. All expansion dimensions can be predetermined based on the material compensation of the T-seal 100 and/or the configuration of the projection 105. For example, the expansion dimension can be dependent on the angle of the top and bottom surface of the projection 105 in relation to the horizontal plane extending from the main body 103 of the T-seal 100.

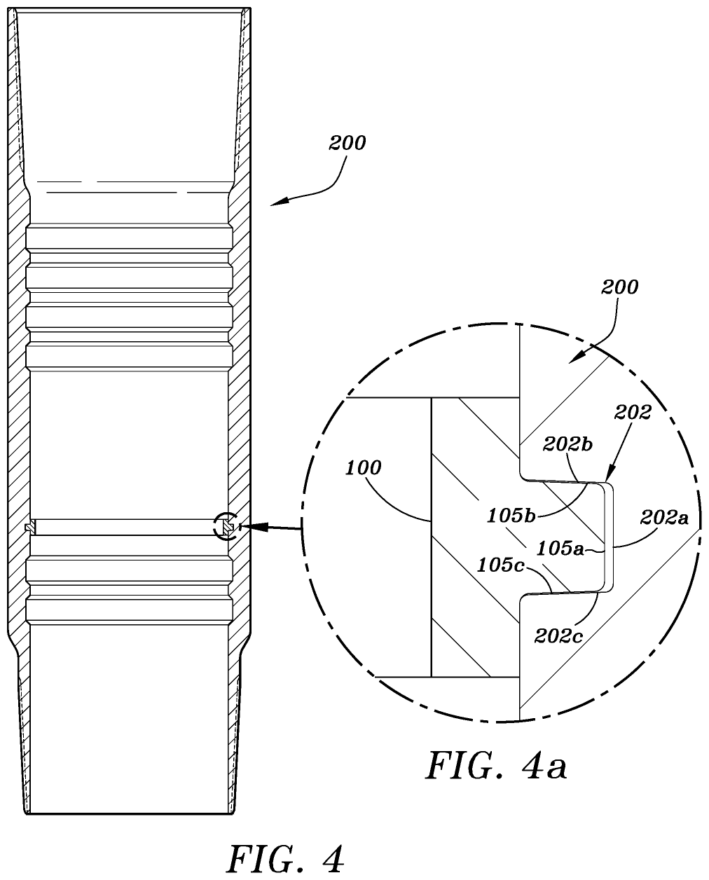

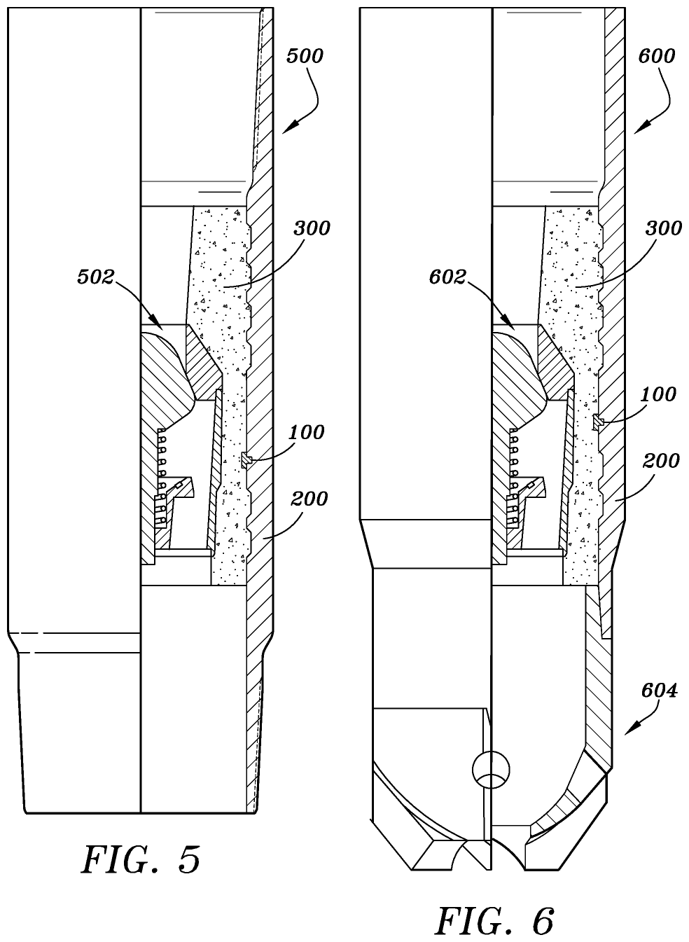

FIG. 4 depicts a cross-sectional view of a shell 200 with a T-seal 100 and FIG. 4A depicts a close-up view of the T-seal 100 in the T-seal groove 202 prior to cementing the valve system within the shell 200 (See FIGS. 5 and 6 below). As shown specifically in FIG. 4a, the gap between the groove wall 202a and the outside or distal surface 105a of the T-seal projection 105 provides the gap necessary to allow the T-seal to expand without causing the T-seal to exit or “pop out” of the T-seal groove 202 during expansion. Moreover, the nature and depth of the T-seal groove top and bottom walls 202b, 202c and the top and bottom surfaces 105b, 105c surfaces of the projection 105 provide structural and frictional support necessary to hold the T-seal in place. The T-seal 100 can be inserted into the T-seal groove 202 any time prior to cementing valve in the float equipment and can be done manually or mechanically.

FIG. 5 depicts a sectional cut-out view of a float collar 500. Once the T-seal 100 is placed in the T-seal groove 202, the float collar assembly can be completed. For example, a valve assembly 502 can be disposed about the center (along a longitudinal axis) of the casing and cemented into place. The float assembly can include one or more of several valve types, and a valve assembly 502 is shown. Most commonly, the valve assembly 502 will include at least one check valve. A check valve is a mechanical device that permits fluid to flow or pressure to act in one direction only and closes automatically when the flow stops or reverses direction. This reverse flow might be encountered either due to a U-tube effect when the bulk density of the mud in the annulus is higher than that inside the drillpipe, or a well control event. Check valves are used in a variety of oil and gas industry applications as control or safety devices. Check valve designs are tailored to specific fluid types and operating conditions. A particular type of check valve includes a flapper valve, that has a spring-loaded plate (or flapper) that may be pumped through, generally in the downhole direction, but will be closed once drilling is complete to prevent fluid from flowing back through the drill string to the surface. The valve assembly 502 can include plunger-type check valve, differential fill-up, and automatic fill-up valve assemblies.

As shown, the T-seal and T-seal groove can generally extend horizontally around the inner diameter of the shell 200. In one or embodiments, the direction of extension can vary from this horizontal alignment to meet specific needs of the float equipment. The T-seal groove can be disposed in the interior of the shell wall at a vertical position that is intended to be within the cementing area. However, its vertical position within that area can be changed depending on a variety of factors. For example, if microannulus formation is suspected at the bottom of the cementing area then the T-seal groove can be disposed in that bottom area. The vertical position of the T-seal groove can also vary depending on the size or diameter of the shell/float equipment. For example, 4.5 in.-5.5 in. diameter shells may have a valve assembly that more tightly fits within the shell. In such conditions, it may be more beneficial to place the T-seal and T-seal groove at a vertical position above the valve assembly to prevent interference.

FIG. 6 depicts a sectional cut-out view of a float shoe 600 with nose 604. Similar to the float collar discussed and described above in reference to FIG. 5, the float shoe 600 can include a valve disposed within the shell 200 and cemented into place. The float shoe 600 can also include a T-seal groove disposed in the interior wall of the shell 200 prior to cementing and can include the same characteristics as described above in reference to FIG. 5. The float shoe 600 can also include a nose 604, which can include a variety of shapes and sizes, each of which is generally selected by the operator based on well structure and characteristics.

During manufacture of the float collar 500 or float shoe 600, the valve assembly is centrally positioned within the shell 200, the T-seal 100 is disposed in the T-seal groove, and cement 300 is poured into the internal volume of the shell 200. The float collar 500 or float shoe 600 is then set aside and given time for the cement to set and dry. The T-seal 100 can react with the moisture (including water) within the wet cement mixture and expand. The T-seal 100 expansion is generally at about eight percent (8%), but can be as little as 0% and as much as 50%. For example, the T-seal 100 can expand as much as 5%, as much as 10%, as much as 15%, or as much as 20%. In another example, the T-seal 100 can expand in a range from about 1% to about 30%, from about 5% to about 40%, from about 10% to about 50%. In another example, the T-seal 100 can expand about 0%, about 3%, about 5%, about 8%, about 10%, about 13%, about 15%, about 18%, or about 20%. As the T-seal 100 expands, it can fill in and tightly seat against the interior surfaces of the T-seal groove, forming a barrier along the interior wall of the shell 200. The end result of deformation of the T-seal can be about 8%. It can be difficult to determine the size change of the T-seal during manufacture of the float equipment because the T-seal expands to a greater percentage initially and slowly shrinks as water evaporates or otherwise reacts with the cement. In most embodiments, the T-seal 100 remains at its expanded size even after the cement 300 is cured and the float collar is put into use.

Referring to FIGS. 5 and 6, the float collar consists of a tubular metal body, the casing, filled with cement or cement-like material having a longitudinal bore surrounding and securing in place a valve made of a composite or aluminum housing. The outer portions of the float shoe are made of steel and generally match the casing size and threads, although not necessarily the casing grade. The inside is usually made of cement or thermoplastic 300, since this material is typically drilled out if the well is to be deepened beyond the casing point. The cement 300 comes in a variety of compositions and is selected based on depth of the well and downhole pressure and temperature, the make-up and design of the valve assembly, casing characteristics, rate of early hydration, and in their ability to resist sulfate attack. Portland Type III cement, a high early strength cement, is commonly used. Portland Type III cement is designed to develop early strength more quickly than a Portland Type I cement (used in general construction). This is useful for maintaining a rapid pace of construction, since it allows cast-in-place cement to bear loads sooner and it reduces the time that precast cement elements must remain in their forms. These advantages are particularly important in cold weather, which significantly reduces the rate of hydration (and thus strength gain) of all Portland cements. The downsides of rapid-reacting cements are a shorter period of workability, greater heat of hydration, and a slightly lower ultimate strength. In one or more embodiments, a shrinkage agent can be added to the cement to minimize the shrinking of the cement as it cures and water evaporates.

The terms microannulus is commonly used in the oil and gas industry to mean a small gap that can form between the casing or liner and the surrounding cement sheath. In this disclosure, the reference to a microanulus is specifically referring to a small gap formed between the shell and interior cement used to manufacture the float equipment.

One or more events can cause one or more microanulus to form between the cement and the interior wall of the casing. For example, if the float shoe or float collar experiences turbulence or impacts with the well bore walls as the casing string is run down hole, a microannulus can form by shifting or cracking of the cement or deformation of the casing. In a second example, a microannulus can form due to variations in temperature and/or pressure before and after the cementing process and before and/or after float equipment is run down hole. In a third example, a microannulus can form due to oils on the inside surface of the casing which prevent the cement 300 from properly bonding with the casing wall. In a forth example, and perhaps most common, a microannulus can be formed during the shrinkage of the cement during the manufacture of the float equipment. The microannulus, however formed, is unwanted and can cause partial or total failure of the float equipment by allowing fluid to flow through the microannulus while running casing cement and other liquids through the float equipment, either during surface testing or downhole operation.

However, when a T-seal is used as disclosed herein, the effects of the microannulus can be halted. From any one of the contributing factors mentioned above, a microannulus can form below or above the T-seal, but the T-seal can effectively prevent the gap from continuing past the T-seal. For example, a microannulus can form below the T-seal and the T-seal can stop the microannulus from travelling upward past the i-seal and/or prevent fluids from traveling past the T-seal. In doing so, the T-seal allows the float shoe or float collar to remain workable despite an otherwise incurable defect.

Various terms have been defined above. To the extent a term used in a claim is not defined above, it should be given the broadest definition persons in the pertinent art have given that term as reflected in at least one printed publication or issued patent. While the foregoing is directed to embodiments of the present invention, other and further embodiments of the invention may be devised without departing from the basic scope thereof, and the scope thereof is determined by the claims that follow. Moreover, an ordinary person having skill in the art should understand that this T-seal and associated float shoe and/or float collar and its components can be manipulated and reconfigured to accomplish similar goals of preventing micro-annulus leakage.

1-6. (canceled)

7. An apparatus for down hole cementing, comprising:
a generally cylindrical shell having an internal volume;
a T-seal groove disposed in the interior wall of the shell; and
a T-seal comprising a main body and a protrusion, wherein the T-seal is removably disposed in the T-seal groove and wherein the T-seal groove has a predetermined depth and a predetermined height corresponding to the dimensions of the T-seal.

8. The apparatus of claim 7, wherein the T-seal comprises a material that expands when contacted with water.

9. The apparatus of claim 7, wherein the T-seal comprises an expandable material.

10. A float collar comprising:
a shell having a cylindrical body and an internal volume;
a valve assembly centrally disposed in the internal volume and cemented into place; and
a T-seal comprising a main body and a protrusion, where the T-seal is disposed in a T-seal groove and wherein the T-seal is expandable when the cement is poured into the internal volume during manufacture of the float collar.

11. A float collar, comprising:
a generally cylindrical shell having an internal volume;
a T-seal groove disposed in the interior wall of the shell;
a T-seal comprising a main body and a protrusion, wherein the T-seal is removably disposed in the T-seal groove;
a valve assembly disposed in the shell about a central axis; and
cement disposed in at least a portion of the internal volume of the shell.
